(19) United States
(12) Patent Application Publication
(10) Pub. No.: US 2019/0234117 A1
(43) Pub. Date: Aug. 1, 2019

(54) SENSING SYSTEM FOR DETECTING ACTUATION OF A HANDLE DEVICE OF A VEHICLE

(71) Applicant: HUF HÜLSBECK & FÜRST GMBH & CO. KG, Velbert (DE)

(72) Inventor: Hubert Bextermöller, Mülheim an der Ruhr (DE)

(21) Appl. No.: 16/327,800

(22) PCT Filed: Aug. 15, 2017
(86) PCT No.: PCT/EP2017/070669

§ 371 Date: Feb. 22, 2019

(30) Foreign Application Priority Data
Aug. 23, 2016 (DE) 10 2016 115 570.5
Sep. 5, 2016 (DE) 10 2016 116 578.6

(51) Int. Cl. E05B 81/78; E05B 85/10

(52) U.S. Cl. CPC E05B 81/78; E05B 85/103; E05B 85/107

(57) ABSTRACT

The invention relates to an acquisition system (200) for detecting the actuation of a handle device (10) of a vehicle (1), comprising a movement device (20) for moving a handle part (11) of the handle device (10) from a resting position (I) into an operating position (II), wherein the movement device (20) for effecting the movement of the handle part (11) can be brought into a first motion course (A), and, after complete conduction of the first motion course (A), can be brought into a second motion course (B). According to the invention, it is provided that a comparison sensor element (56) and an actuation sensor element (57) are arranged on the movement device (20), so that the first motion course (A) can be assessed by a first detection of the comparison sensor element (56) and by a second detection of the actuation sensor element (57), and the second motion course (B) can be assessed by the second detection of the actuation sensor element (57), whereby the actuation can be detected.

The present invention relates to an acquisition system for the detection of an actuation in a handle device of a vehicle according to the type further defined in the preamble of claim 1.

The invention further relates to a handle device according to the preamble of claim 5, as well as to a method for detection of an actuation of a handle device according to the preamble of claim 15.

It is known from the prior art that a sensor is used for the detection of an actuation in a handle device, in particular for the detection of a short stroke, which sensor is arranged on the handle part of the handle device, for example. Through this direct arrangement on the handle part, the actual position of the handle part can be detected, and an actuation can be concluded upon a sufficient alteration of the position. This detected actuation then leads, e.g., to an actuation of a locking device of a vehicle and/or to the initiation of an authentication process.

It has here, however, been proven to be disadvantageous that, in the detection of the actuation, movements are also detected, which do not serve the actuation of the handle part. In particular movements like shearing forces or heat-related deformations on the handle part can here elicit a false detection of the actuation. Measures to avoid and/or reduce such false detections are here frequently constructively complex, and associated with high costs.

It is therefore an object of the present invention to at least partially eliminate the previously-described disadvantages. In particular, it is the object of the invention to make a more cost-effective and/or simpler and/or more reliable detection of the actuation in a handle device possible. Moreover, it is in particular an object to be able to conduct a detection or query of the actuation, which fulfills a high security standard.

The above object is achieved through an acquisition system with the features of claim 1, through a handle device with the features of claim 5, as well as through a method with the features of claim 15. Further features and details of the invention result from the respective dependent claims, the description and the drawings. Here, features and details, which are described in conjunction with the acquisition system according to the invention, of course also apply in conjunction with the handle device according to the invention, as well as the method according to the invention, and vice versa, so that, with respect to the disclosure, reference is or can always reciprocally be made to the individual aspects of the invention.

The object is in particular achieved through an acquisition system for the detection of an actuation (in) a handle device of a vehicle, comprising a movement device for movement of a handle part (e.g. door handle) of the handle device from a resting position into an operating position. The movement device can here include e.g. at least one gear-mechanism element or the like, in order to transmit at least one movement.

The vehicle is e.g. configured as a motor vehicle and/or as a passenger motor vehicle and/or as an electric vehicle and/or as a self-driving (autonomous) vehicle.

Preferably, it is provided here that the movement device, to effect, i.e. in particular transmit and/or generate the movement of the handle part, can be brought into a first motion course, in particular through a drive device, and after (particularly complete) conducting of the first motion course, can be brought into a second motion course, in particular through the handle part.

It is preferably provided here that a comparison sensor element and an actuation sensor element are arranged on the movement device, so that the first motion course A is assessible through a first detection of the comparison sensor element and through a second detection of the actuation sensor element (in particular simultaneously). Preferably, the second motion course B is assessible (in particular only) through the second detection of the actuation sensor element, whereby the actuation is detectible. In other words, through the first detection through the comparison sensor element, and through the second detection through the actuation sensor element, the first motion course can be established, wherein (in particular exclusively) the second motion course is assessed based on the second detection through the actuation sensor element. Advantageously, at least two sensors are thus available, in order to differentiate, in particular, the first motion course from the second motion course. To that end, e.g. a comparison of the first detection with the second detection can be carried out, wherein the comparison sensor element preferably serves as a reference. The advantage is thereby achieved that a particularly simple and reliable detection of the actuation of the handle device is possible, wherein the first motion course can reliably be distinguished from the second motion course.

Moreover, it is conceivable that a diagnosis, preferably an ASIL-relevant diagnosis (ASIL—Automotive Safety Integrity Level, in particular according to ISO 26262), in particular of the acquisition system, can be carried out. The diagnosis is, e.g. carried out in such a manner that, based on the diagnosis, an error-free state or an error state of the handle device or of the acquisition system or of individual sensors is directly determinable.

To that end, a comparison of detecting values with comparison values preferably occurs, particularly preferably in a redundant manner. The detecting values can preferably be determined through the first and/or second detection. The comparison is e.g. arithmetically carried out through a processing unit. Thus, the advantage can also be achieved that an ASIL-compliant detection of the actuation is possible. It is in particular provided here to conduct, for risk-minimization, a diagnosis of the functionality of the circuit (i.e. in particular of the named sensor elements). Thus, it is in particular enabled to achieve, cost-effectively, a high ASIL-level, i.e. an increased security. Here, preferably a drive device, in particular a motor, preferably a servomotor or a stepper motor, of the handle device can be driven with high loads, and yet a good and reliable diagnosis can occur.

Here it is preferably possible, that, in the first motion course, the movement device actively moves the handle part (this corresponds to a first motion course, or a transmission of the movement from the movement device to the handle part, effected through the movement device), in particular longitudinally displaceably, and the movement device is moved through the actuation of the handle part in the second motion course (this corresponds to a second motion course effected through the handle part, in particularly through a rotating and/or pivoting, or a transmission of the movement from the handle part to the movement device). A particularly simple and cost-effective implementation of the acquisition system is thereby possible.

It can further be possible that the movement device includes a first movement element and a second movement element, which elements are at least (or only) coupled with one another (mechanically), in the first motion course, for movement transmission, wherein the comparison sensor element is oriented towards the first movement element, in order to detect a movement of the first movement element through the first detection, and the actuation sensor element is oriented towards the second movement element, in order to detect a movement of the second movement element through the second detection. In particular, it can be possible that the first movement element and the second movement element are (mechanically) decoupled from one another in the second motion course. This has the advantage that the first motion course can be reliably differentiated from the second motion course.

Preferably, the comparison sensor element conducts the first detection in order to quantitatively detect and/or monitor the movement of the first movement element. Particularly preferably, the actuation sensor element conducts the second detection in order to quantitatively detect and/or monitor the movement of the second movement element. The first movement element and/or the second movement element are here preferably fixedly arrangeable (meant is: stationarily, but rotatable) in a handle device, so that error influences can reliably be avoided.

In addition, it is advantageous, if the comparison sensor element and the actuation sensor element are connected with a (in particularly one) assessment device, so that (in particular only) the first motion course of the movement device is assessible, in particularly redundantly and/or identically, by means of the first and second detection through the assessment device, and in particular the first motion course is redundantly monitorable and reviewable, in order to conduct a plausibility check and/or detection of a false first motion course. In particular, non-plausible working regions can also thusly be detected thereby in that a coupling of the first movement element with the second movement element is assessed in the first motion course. If the first detection here differs from the second detection, and/or the first movement of the first movement element from the second movement of the second movement element, then a false mechanics and/or electronics can be concluded therefrom. E.g. the movement device can then suffer damages, so that e.g. a corresponding error message can be initiated. This has the advantage that a false state of the movement device and/or of the handle device can securely and reliably be detected. Here, it is conceivable that a test run for functionally checking the handle device according to the invention is automatically conducted, whereby the security is additionally increased.

In particular, “similar” means, with reference to at least two courses, such as the course of the detections and/or a first and second detecting value course, that both courses are specific for an identical process, e.g. for a first motion course. Preferably, similar courses are present, if e.g. the courses suggest a same absolute rotary angle, i.e. a quantitatively same rotation without consideration of the sign or rotatory direction. This is in particular true when the movement elements, e.g. as toothed gears or shafts, have the same transmission ratio with respect to the movement of the handle part. In place of the detection of a rotation, force and/or length alteration can also be detectable.

Furthermore, it is optionally possible within the scope of the invention that the actuation sensor element and/or the comparison sensor element are configured as similar-type sensors, preferably respectively as rotary sensor (rotational sensor), preferably as magnetic sensor, e.g. Hall sensor. In particular, a rotation of the movement elements can thus, in a simple manner, be detected.

It can also be enabled that at least one of the sensor elements, i.e. e.g. actuation sensor element and/or the comparison sensor element, are configured as at least one of the following sensors:
rotary-angle-sensor, which is preferably integrated in a drive device,
electric and/or electronic sensor, preferably rotary sensor,
active measuring sensor,
passive measuring sensor,
capacitive sensor,
mechanical sensor,
piezoelectric sensor,
inductive sensor,
optical sensor,
magnetic sensor (in particular Hall sensor).

In particular, it can be possible that at least one of the sensor elements is arranged in the region of a mounting place of the handle device, in order to detect a rotary movement and/or a translatory movement.

Likewise, under a “sensor”, electric information, e.g. an actuation information, preferably for a motor, can, in the broader sense, be understood. Thus, it can e.g. be provided, that, in the first detection for establishing the first detection result, an actuation signal is assessed as actuation information for a motor. It can also be possible, that, in the second detection, to establish the second detection result, an acquisition signal, preferably a measuring signal, e.g. of a hall sensor, is assessed. Of course, it is also possible that both sensor elements (or also further sensor elements) are provided, which are configured in a similar manner (e.g. acquisition actuation signals or measuring signals, respectively).

Preferably, it can be provided that the actuation sensor element and/or the comparison sensor element are arranged (e.g. directly and/or immediately) on a circuit board, (in particular of the handle device). In particular, the actuation sensor element and/or the comparison sensor element are connected, electrically-conductively, with a circuit board track and/or with further electronic components (of the handle device). The electronic components include e.g. a processing unit of the handle device. Preferably, at least one of the movement elements comprises (respectively) a pin element (e.g. a pin, a rod, or the like), wherein the respective movement element preferably is arranged such that the respective pin element plunges into the actuation sensor element or the comparison sensor element and/or plunges, respectively, into a mounting element with, respectively, the actuation sensor element or the comparison sensor element. In particular, the actuation sensor element and/or the comparison sensor element are here respectively configured as a Hall sensor element. Preferably, the pin element includes at least one magnetic element (magnet element). Thus, a simple and space-saving detection is possible on the respective movement element. Preferably, the actuation sensor element and/or the comparison sensor element is arranged in/integrated into a rotary axle for the handle part. The pin element can e.g. also be configured as a pivot, and preferably be rotatably supported and/or can be pivotable, in particular in the rotary axle.

Preferably, at least one of the movement elements can include a magnetic element. In particular, the magnetic element is arranged on the respective movement element in such a manner that, in a movement of the movement element (a movement of the magnetic element also occurs and) the movement can be detected by means of a change of a magnetic field, wherein, preferably, the magnetic field is generated by the magnetic element. Preferably, a first movement element is here arranged with a first magnetic element in the region of the comparison sensor element, and a second movement element is arranged with a second magnetic element in the region of the actuation sensor element. Preferably a first pin element (in particular with the first magnetic element) of the first movement element is plunged into the comparison sensor element. Particularly preferably, a second pin element (in particular with the second magnetic element), of the second movement element, is plunged into the actuation sensor element.

Optionally, the respective movement element can at least partially be formed of metal and/or plastic material and/or comprise a ferromagnetic material. In particular, at least one of the movement elements is configured as part of the handle part, preferably rigidly and/or co-rotationally and/or non-displaceably fastened to the handle part, particularly preferably monolithically with the handle part. Preferably, a force and/or a movement and/or a moment, in particular torque, is then transmitted, here, through the movement of the handle part, to the (in particular second) movement element. In particular, a movement of the movement element then occurs relative to the respective sensor element, i.e. in particular the movement of the first movement element relative to the comparison sensor element and the movement of the second movement element relative to the actuation sensor element. In this fashion, the movement of the movement element can be reliably detected. Preferably, the movement element is configured as a rotatory axle of the handle part. As “co-rotational”, it is here understood in particular, that the respective movement element “co-rotates” with the handle part, in particular around the handle part rotatory axle.

It is further conceivable that the first motion course of the movement device can be assessed redundantly and/or similarly through the first and second detection. Here it can in particular be determined a first (temporal) detecting value course by means of the first detection, and a second (temporal) detecting value course by means of the second detection, which courses are in particular similar. Similar refers e.g. thereto that e.g. a determined, absolute rotary angle difference is identical or proportional, wherein the direction of the rotation can be different. In particular, the second motion course of the movement device is non-redundantly assessible, wherein preferably, in the second motion course, the first detecting value course is different from the second detecting value course, in particular different in manner (e.g. has a different absolute rotatory angle difference). Preferably, only the second detecting value course is specific to the second motion course, and the first detecting value course is non-specific to the second motion course. This is in particular connected to the fact that, in the second motion course, substantially no rotation of the first movement element occurs. The movement of the first movement element is thereby, in a standstill of the handle part identical to a movement of the first movement element in the second motion course, that is, if a movement of the handle part occurs. Correspondingly, it cannot be distinguished by means (only) of the first detecting value course, if the handle part is in a standstill or moves in a second motion course. The first detecting value course is thus non-specific for the second motion course. This, however, has the advantage that, through the comparison of the first detecting value course with the second detecting value course, the second motion course can be reliably detected. That is because the movement of the second movement element in the second motion course, ascertainable by means of the second detecting value course, differs significantly from the movement of the second movement element, in a standstill of the handle part.

It can also be possible that both the first motion course of the movement device and the second motion course of the movement device are redundantly and/or in a similar fashion assessable by the first and the second detecting.

Likewise object of the invention is a handle device for a movable part of a vehicle, in particular for opening the movable part, in particular a door or a trunk lid or the like, with a movably-mounted handle part and a movement device.

Preferably, it can be provided that the handle part can be moved from a resting position into an operating position, by at least a first motion course of the movement device, and the handle part can be manually actuated in the operating position (in particular for opening of the movable part), so that upon actuation, at least a second motion course of the movement device occurs.

Here, it is in particular provided that at least one comparison sensor element and one actuation sensor element are arranged on the movement device, so that the first motion course can be assessed by a first detection of the comparison sensor element and by a second detection of the actuation sensor element, and the second motion course is (in particular only) assessable by the second detection of the actuation sensor elements, whereby the actuation of the handle part can reliably be detected.

In this way, the handle device according to the invention provides the same advantages as have already been described with reference to an acquisition system according to the invention. In addition, an acquisition system according to the invention can be provided with the handle device according to the invention.

It can be further advantageously provided that at least two (or also three) movement elements of the movement device are provided, which in particular are configured as at least one rotatably-supported gear and/or as a lever on a, in particular stationary axle of the movement device and/or handle device, or are configured as at least one rotatably-supported shaft, wherein the comparison sensor element is oriented towards a first movement element and the actuation sensor element is oriented towards a second movement element, wherein the movement elements can respectively be brought into a different operative connection with the handle part, so that preferably a first movement of the movement device in the first motion course can be detected redundantly and/or similar and/or both by the comparison sensor element and the actuation sensor element, in particular a second movement of the movement device in the second motion course can be detected differently by the comparison sensor element and the actuation sensor element, so that the actuation is detectable by means of a comparison of the first and the second detection. In particular, a comparison of the first and the second detection enables that error influences and/or disturbing movements of the handle part, which are not to cause an actuation, are reliably identified. For example, at least one sensor means can be provided, in order to detect the movement of the movement element, e.g. a rotatory angle or the like.

It is also advantageous, if the actuation sensor element and/or the comparison sensor element each comprise multiple sensor means, such as the magnetic sensor, to conduct the detection. The sensor means can e.g. be arranged at a distance, in order to detect a travel distance of a movement of a lever of the movement element. An indicator, such as a magnetic element, is attached to the lever to that end, for example.

It can be provided, in another option, that the comparison sensor element and the actuation sensor element are respectively arranged in the region of different movement elements of the movement device, wherein the movement elements are in each case configured at least rotatable (and/or translatorily movable and/or pivotable), in particular as rotation elements, preferably as a shaft and/or as a gear and/or stationary (but rotatable) axle and/or lever system, so that preferably the comparison sensor element and the actuation sensor element are configured as rotation sensors for detection a rotation of the movement elements. The respective movement element is in each case movably arranged and/or mounted on a fixed axle, so that the movement device comprises two different, in particular stationary, axles, on which the movement elements are arranged.

Here and in the following, the term “fixed” in particular refers to the (stationary but rotatably) arrangement in the handle device, “fix” does in particular not refer to the rotatability. The fixed arrangement therefore preferably effects that a translatory movement (e.g. of the movement element) is prevented in a movement of the handle part, but that a rotation (e.g. of the movement element) can take place. This way, disturbing influences, such as shear forces onto the handle part, can reliably be prevented for detection.

Advantageously, it can be provided in the scope of the invention that the comparison sensor element and the actuation sensor element are arranged in the region of different movement elements of the movement device, wherein the movement elements are in each case configured (translatory) fixed, and in particular inside a carrier element, in particular a mounting carrier, of the handle device. This way, it is ensured that disturbing forces on to the door handle do not significantly impact the movement of the movement elements in the first and in the second motion course, so that the detection of the actuation of the handle part is enhanced.

It can further be provided, in the scope of the invention, that the actuation sensor element is configured as a short-stroke sensor, so that the actuation of the handle part in the second motion course can be detected as a short stroke, in particular using an assessment of a rotation of a (first) movement element. Here, actuation of the handle part is in particular carried out as a short stroke of the handle part, so that merely a slight movement of the handle part in a direction away from the movable part is effected. Here, the short stroke is effected by an impact of force, in particular by a user of the vehicle. This comes with the advantage that a very comfortable and simple actuation operation can take place.

It can be provided in the scope of the invention that the movement device is connected to and/or comprises a drive device, in particular a motor, preferably a servomotor or a stepper motor, whereby a first movement element of the movement device can directly be driven by the drive device, so that a drive movement of the drive device can be transmitted to the first movement element, and can be transmitted to the drive device as a first movement in the first motion course, and indirectly, in particular via the handle part, to a second movement element of the movement device. In particular, the first and/or second movement element are coupled to one another during the first motion course. This way, a simple and comfortable actuation of the handle part is enabled, because the handle part is moved away from the movable part to such an extent that gripping of the handle by the hand of the user is possible.

Further advantageously can be provided that a first movement element of the movement device can be brought in operative connection with the handle part via a transmission element, such that a first movement in the first motion course can be transmitted, from the first movement element, to the transmission element and then to the handle part, wherein the first movement, in the first motion course, and a second movement, in the second motion course, can be transmitted from the handle part to the second movement element, wherein a decoupling element is provided, in order to compensate and/or to prevent and/or to change a transmission of the second movement of the handle part to the first movement element. This way, in particular the decoupling of the first from the second movement element can be effected in the second motion course, in order to thereby increase the reliability of the detection of the second motion course.

Preferably, it can be possible that the decoupling element is configured as a (e.g. pressure) spring or spring assembly (with multiple springs), wherein preferably the handle part is applied with the pressure of the spring, and in particular the spring is fastened both on the handle part and on the transmission element. Of course, also a comparable means can be used as the decoupling element, e.g. in order to compensate the movement in a certain direction in the first motion course.

It can be possible that the comparison sensor element and/or the actuation sensor element are in each case configured as a sensor, in particular as an optical or resistive or inductive or mechanical sensor or the like. In particular, the comparison sensor element and/or the actuation sensor element is formed (translatorily) fixed, in particular stationary, and, with respect to the arrangement in the handle device, is therefore (translatorily) moved neither in the first motion course nor in the second motion course.

The first movement element is in particular configured as an active movement element, and thus actively transmits a movement to the handle part. The second movement element is preferably configured as a passive movement element, and thus preferably does not transmit a movement to the handle part, in particular in the second motion course.

It is furthermore conceivable that, in the resting position, the handle part is arranged flush with the outer side of the movable part, in particular a vehicle body and/or a door plate, and in the operating position, protrudes from the outer side of the movable part in a projection-like manner, so that a manual actuation, in particular movement, of the handle part can be conducted by a user of the vehicle. This way, a simple actuation of the handle part, e.g. for opening of the movable part, can be effected with a sufficient exertion of force for opening.

It can be possible that the handle part, in the movement from the resting position to the (e.g. first and/or second) operating position (and/or vice versa) at least partially conducts a translatory movement and/or at least partially a rotary movement. In other words, the movement of the handle part can have more than one movement component, wherein the translatory movement is effected simultaneously with the movement device, for example. The rotary or translatory movement is effected in particular (at least in part) by the movement device. Preferably, the movement device includes at least one pin element (e.g. per movement element), which is preferably guided in respectively one bearing element, e.g. in a rotary bearing and/or is respectively guided in one of the sensor elements. In particular, the handle part is displaceably and/or rotatably mounted in the handle device, preferably in the movement direction. For example, the movement device and/or the individual movement elements are configured as rotary bearings or similar. Preferably, the handle part is configured as a rotary handle, pull handle or pivot handle, in particular with a bearing axle or guide track. In particular, the door handle is mounted on at least a first and/or second bearing axle. In particular, at least one of the bearing axles is configured as a rotary axle. Preferably, the comparison sensor element is arranged in the region of the first bearing axle and/or the actuation sensor element is arranged in the region of the second bearing axle. Preferably, at least one of the bearing axles includes respectively at least one of the movement elements in order to make the rotation and/or translation possible. The bearing axles can here preferably comprise metal and/or plastic material. Preferably, the bearing axle, in particular the movement element, each includes a magnetic element. For detection, the respective magnetic element can preferably be operatively connected with the comparison sensor element or actuation sensor element, e.g. plunged therein. Furthermore, one or multiple connecting elements can be provided, which elements connect the respective movement element and/or a respective pin element with the handle part mechanically such that, through a movement of the respective movement element (or pin element), the rotatory or translatory movement of the handle part is possible.

Furthermore, it can be optionally possible, that at least one of the movement elements (in particular the first and/or second movement element) respectively comprises at least one magnetic element. The movement elements are respectively movably, preferably rotatably, configured in particular as shafts, or lift bearing or axle or the like. Preferably, the movement elements are respectively designed (substantially) cylindrically and/or circular-cylindrically and preferably include two axial ends. At least one of the movement elements can include, preferably on one of the respective axial ends, a magnetic element. The respective magnetic element includes e.g. a north/south polarity, so that a movement, in particular a rotation of the respective movement element, can reliably be detected by means of an alteration of the magnetic field. Preferably, the sensor elements, e.g. as Hall sensors, are arranged in direct proximity or neighboring to the magnetic element, to detect the magnetic field. The sensor elements include e.g. the comparison sensor element (e.g. in the region of a first magnetic element of a first movement element) and the actuation sensor element (e.g. in the region of a second magnetic element of a second movement element).

It can furthermore also be possible that, by means of the detection of the respective movements of the movement element, a motion course of the handle part is determined. Preferably, a first detection of a first movement of the first movement element and a second detection of a second movement of the second movement element are conducted. Preferably, the motion course of the handle part includes different movement phases, which, particularly preferably, can be established and differentiated with one another by means of a qualitative and/or quantitative assessment of the respective detection, and/or by means of a comparison of the respective detection.

In particular, it can be possible that the sensor element, in particular the actuation sensor element and/or the comparison sensor element, is configured to conduct a contactless detection, in particular measurement, and/or a rotary angle measurement and/or a continuous detection of a position, in particular of at least one of the (first and/or second) movement elements. Alternatively or additionally, it can be possible through the detection to detect different positions, in particular rotary-angle positions, in particular of the first and/or second movement elements. In other words, it can be possible that, through the detection, not only the end position, but rather also the intermediate positions of at least one of the movement elements are detected. The positions can e.g. be detected continuously, or at least four or six or 10 or 20 or 30 positions for a respective movement element can be differentiated. In particular, the position of at least one of the movement elements can be detected with a resolution of at least 5°, or at least 2°, or at least 1°, or at least 0.1°, by at least one of the sensor elements. The advantage is thus achieved that a particularly exact and differentiated detection is possible, so that, e.g. error states or mechanical wear or the like can also be reliably recognized. The contactless detection further permits the wear to be reduced in the detection.

In particular, it can be possible that a decoupling element is provided, in order to change, in particular to compensate for and, in particular in comparison with the transmission of the movement of the handle part on to the second movement element to alter, the transmission of the movement of the handle part on to the first movement element, in the second motion course. This enables an unambiguous assessment of the first and second acquisition for the detection of the actuation of the handle part.

According to a further possibility, it can be provided that the movement elements are configured as translatorily-fixed parts of the handle device, so that a translatory movement of the movement elements is prevented through the movement of the handle part and/or a distance between the movement elements and the handle part is increased proportionally to a motion course of the handle part in the first motion course and/or in the second motion course. In particular, the distance to one another between the movement elements, and/or to a mounting carrier of the handle device and/or to the outer side of the movable part can be substantially constant and/or remain constant during the first and second motion course.

It can furthermore be possible that, in the second motion course, a manual operation and/or movement of the handle part can be conducted, and in particular, in the first motion course, a movement of the handle part occurs exclusively automatedly, preferably controlled and/or regulated, in particular through the movement device and/or the drive device. In particular, the manual actuation is here prevented in the resting position, so that an accidental triggering of the actuation can reliably be avoided.

It is alternatively or additionally conceivable that the handle part can be moved into the resting position, and into at least one operating position, in particular open position and/or outward position, wherein in particular the handle part is operable in the at least one operating position, in particular a first open position (first outward position), for opening of the movable part, and in particular, in a movement into a second open position (second outward position) effects an actuation of a closing device. The movement into the second open position is effected in particular through the actuation of the handle part, in particular through a short stroke. Furthermore, it can be possible that the handle part, in the resting position, is arranged flush with outer surface of the movable part, and, in the (first and/or second) open position protrudes from the outer surface and/or is operable for opening of the movable part.

Furthermore, it is conceivable within the scope of the invention, that a first movement of the handle part from the resting position into the (first) open position occurs in the first motion course, and can be conducted in particular through the drive device, and in particular, a second movement of the handle part from the (first) open position into a second or further open position occurs in the second motion course, and in particular, for opening the movable part, occurs manually by an operator. Here, it can be possible that in the resting position and/or in the first motion course, an operation of the handle part, for opening the movable part, is prevented, in order to prevent an accidental actuation.

Moreover, it is optionally possible, that a locking unit is provided to arrest the handle part, in order to prevent the transition of the handle part into the first and/or second motion course, in that the locking unit engages form- and/or force-fittingly into the handle part, and/or holds the handle part, so that preferably a first and/or second movement is prevented, wherein preferably the locking unit releases, in movement, the handle part during the first and/or second motion course. An accidental actuation, in particular during travel, is thusly avoided.

Furthermore, it can be possible that, in the movable part, in particular a door, in particular a door plate, an opening is provided for the handle device, which opening is substantially closed by a recessed grip, and wherein in particular the recessed grip, together with a handle bracket and/or a carrier element, form- and/or force-fittingly holds the handle device in the opening on the door plate. Here, it is in particular conceivable that the at least one—in particular fixed—movement element and/or the comparison sensor element and/or the actuation sensor element are arranged and/or fastened and/or rotatably supported in such a manner, in the handle device, that a distance between the movement element or the comparison sensor element or the actuation sensor element, and the recessed grip and/or the handle bracket, remains constant in the first and second motion course. The reliability and susceptibility to errors is thereby improved for the detection.

Furthermore, it can be advantageous within the scope of the invention, if, in an actuation of the handle part, an electronic signal can be generated, whereby in particular a security system and/or a convenience electronics of the vehicle, can be turned on.

Advantageously, it can be possible that the handle part is spring-loaded in such a manner, in particular through the decoupling element or a further spring element, that the handle is always pressed into its resting position, wherein, preferably, the movement device acts against the spring force. Alternatively or additionally, it can be possible that the handle part is spring-loaded in such a manner that the spring force acts against the second movement (in the second motion course) of the handle part, so that the handle part, in the second movement, is pressed, through the spring (force), in the direction of the (first) operating position or open position and/or resting position. The convenience in operation is thereby substantially increased.

Likewise subject-matter of the invention is a method for the detection of an actuation of a handle device for a movable part of a vehicle, in particular to open the movable part, in particular a door or a trunk lid or similar, with a movably-mounted handle part and a movement device.

The actuation is released, e.g. in the operating position, and includes in particular a (manual) exertion of force on the handle part, preferably a manual pressing or pulling or similar on the handle part.

It is hereby preferably provided that, through at least a first motion course of the movement device, the handle part is moved from a resting position into an operating position (open position), and the handle part, in the operating position, is released for (in particular manual) actuation, so that, in this (in particular manual) actuation, at least one second motion course of the movement device occurs, in order to preferably open the movable part.

Preferably, the following steps can be provided within the scope of the method according to the invention, which steps can in particular be conducted successively or in any desired order, wherein, preferably, individual steps can also be repeatedly conducted:
conducting of at least a first detection through at least one comparison sensor element to establish a first detection result, in particular a first detection result course,
conducting at least a second detection through at least one actuation sensor element for establishing a second detection result, in particular a second detection result course,
comparing of the first detection result with the second detection result for establishing a comparison result (in particular through an assessment device), so that, by means of the comparison and/or the comparison result, the second motion course is detected in order to detect the actuation of the handle part, and preferably the first motion course is differentiated from the second motion course, so that preferably, by means of the assessment, the first motion course is also detected.

In other words, the comparison, in particular the difference in the first and the second detection, is used in order to differentiate the first motion course from the second motion course, and/or to recognize the presence of the second motion course, and thereby to detect the actuation of the handle part. This way, it can be concluded, upon a detection of the second motion course, that an actuation of the handle part is present, as in particular the second motion course is initiated and/or effected by the actuation of the handle part, in particular by the movement of the handle part here. In particular, one of the two motion courses has a different effect on the first and second movement element, or on the first or second detection, respectively. The difference in the first detection and in the second detection is enabled e.g. by a comparison of a first detecting value course, which is determined by means of the first detection, and of a second detecting value course, which is determined in the second detection.

This is why the method according to the invention comes with the same advantages as have been described in detail with reference to an acquisition system according to the invention and/or a handle device according to the invention. In addition, the method can be suitable for the operation an acquisition system according to the invention and/or a handle device according to the invention.

The first and the second detection are preferably conducted such that, not only by means of the first detection, or only by means of the second detection, the first motion course can be differentiated from the second motion course, but in particular the first motion course is to be differentiated from the second motion course only by means of the comparison result. In other words, it can be possible that exclusively the comparison result is significant for the first and second motion course. In particular, this is the case if the assessment by means of the second (or first) detection alone does not allow a statement on whether a first or a second motion course is present (e.g. if the second movement element moves similarly both in the first an in the second motion course). Alternatively, it can also be possible that exclusively the second detection is significant for the second motion course (in particular if the second movement element moves differently for the first and second motion course).

It is in particular provided that the comparison sensor element and the actuation sensor element are arranged on the actuation device, such that the first motion course can be assessed by the first detection of the comparison sensor element and the second detection of the actuation sensor element, and the second motion course can be assessed, in particular exclusively, by the second detection of the actuation sensor element, whereby the actuation of the handle part is detected.

The manual actuation is particularly conducted as a pulling on the handle part by a user of the vehicle. This allows an especially comfortable actuation, which may transition into an opening movement for the opening of the movable part.

Furthermore, it is optionally provided that the movement device includes a first movement element and a second movement element, which are moved, in particular similar, in a first motion course of a first motion type, and, in particular differently, in a second motion course in a second motion type, so that the difference of the movement (in particular the difference of the motion course) is specific to the actuation of the handle part, and is in particular assessed in the comparing. Here, it is also conceivable that in the first motion course, the movement of the first movement element is effected with another rotational angle and/or absolute rotational angle than the movement of the second movement element, and, nonetheless, the movement and/or detection of this movement is effected similarly, since both, the movement of the first movement element and the movement of the second movement element, is specific to the first motion course.

It can in particular be provided that the first movement element only moves (significantly) in a first movement of the handle part in a first motion course, and the second movement element moves (significantly) both in the first movement and in a second movement of the handle part in the second motion course.

Furthermore, it can be provided in the scope of the invention that the handle part is unblocked in the operating position in order to conduct the, in particular manual, actuation for opening of the movable part, in particular a pushing or pulling on the handle part, and preferably for conducting at least one further, in particular manual, actuation, in particular a pushing and/or pulling on the handle part, so that in particular in the further actuation, at least one further motion course of the movement device occurs, wherein the movement device preferably includes a first movement element and a second movement element, which (in particular both in the first and) in the further motion course are moved in a first (or further) motion type, in particular similarly in such a manner, that the actuation for opening is differentiated from the at least one further actuation by means of the comparison result. Accordingly, the further actuation, i.e. the transition of the handle part into the resting position, can be reliably identified.

It can furthermore be possible, that in the first motion course, the handle part is brought into a first outward position (first open position) relative to the movable part, in particular with a distance to an outer surface of the movable part of at least 1 cm or at least 2 cm or at least 4 cm or at least 6 cm, wherein the actuation for opening the movable part is preferably effected in that the handle part in the second motion course is manually brought into a second outward position (second open position) by a user of the vehicle, in particular by a short stroke, whereby an increase of the distance to the outer surface of the movable part is effected, preferably in the range of 1 mm to 10 mm, particularly preferably 2 mm to 3 mm, wherein the increase is preferably detected using the comparison result and in particular the first outward position is differentiated from the second outward position. This way, a simple actuation for the opening of the movable part is possible.

In particular, it is possible that starting from the operating position (e.g. the first open position), a pushing by the user on the handle part, by the user, in the direction of the movable part, a movement, in particular a rotation of both movement elements is effected, and/or a detection of a movement is effected both by the actuation sensor element and the comparison sensor element. In this way, in particular a first motion course or a further motion course for the transition into the resting position can reliably be detected.

In addition, it is also advantageous, if the second motion course is the detected if the actuation sensor element detects a required outward position of the handle part in the range of 1 mm to 10 mm, preferably 2 mm to 3 mm, in particular by means of the (in particular second) detection of a required rotation of a second movement element in the range of 1° to 10°, preferably 2° to 3°, and, in addition such a detection fails to appear in the comparison sensor element, preferably by means of the (in particular first) detection of a rotation of a first movement element, which preferably is permitted to amount to 1° to 2° at maximum.

In other words, the second motion course is detected then, if the first detection is unspecific and/or the second detection is specific for the second motion course. This way, in particular a difference of the rotation of the first movement element and the rotation of the second movement element is considered for the detection of the second motion course. This also allows that an automatic “orientation” of the actuation sensor element can be effected in that after the complete conducting of the first motion course, an absolute position is measured and/or the first detection is compared to the second detection. This way, e.g. manufacturing tolerances and/or age-related changes in the movement elements and/or in the actuation sensor element and/or in the comparison sensor element and/or in further elements of the handle device can be compensated.

It can further be possible that the first motion course, in particular a position of the handle part in the operating position, determined by means of the first and second detection, is used as a reference for the detection of the actuation of the handle part, preferably for the calibration and/or configuration of a starting value for the establishment of the required outward position of the handle part and/or the required rotation, from which the actuation is detected, in the comparing and/or assessment of the comparison result. In this way, tolerance effects related to the service life can be compensated as well.

Further advantages, features and details of the invention result from the following description, in which exemplary embodiments of the invention are described in detail with reference to the drawings. Here, the features mentioned in the claims and in the description can in each case each individually or in any combination be essential to the invention. Shown are in:

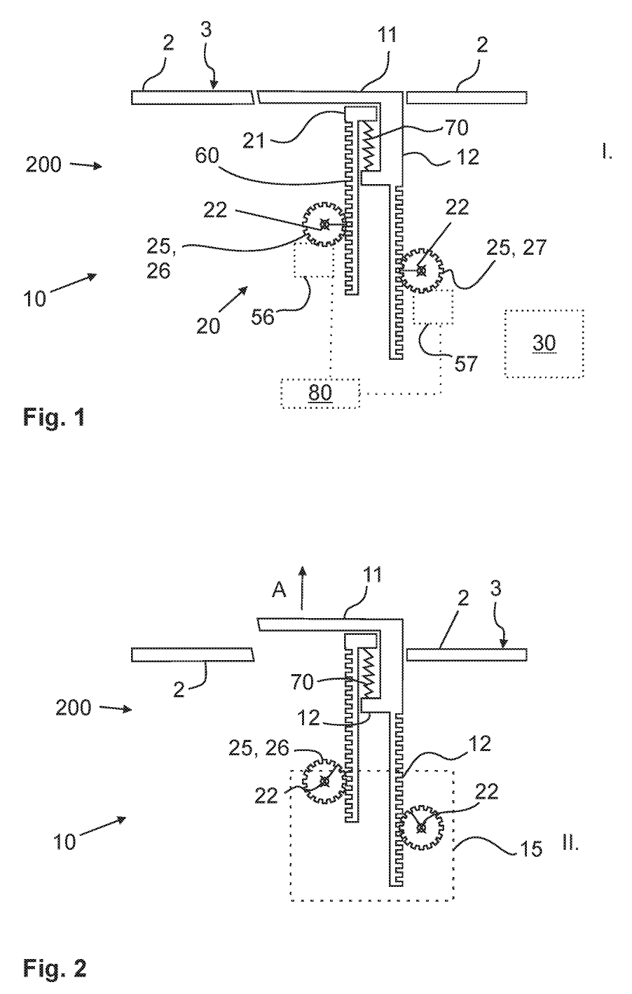

FIG. 1: a schematic view of parts of an acquisition system according to the invention as well as of a handle device according to the invention;

FIG. 2: another schematic illustration of parts of a handle device according to the invention as well as of an acquisition system according to the invention;

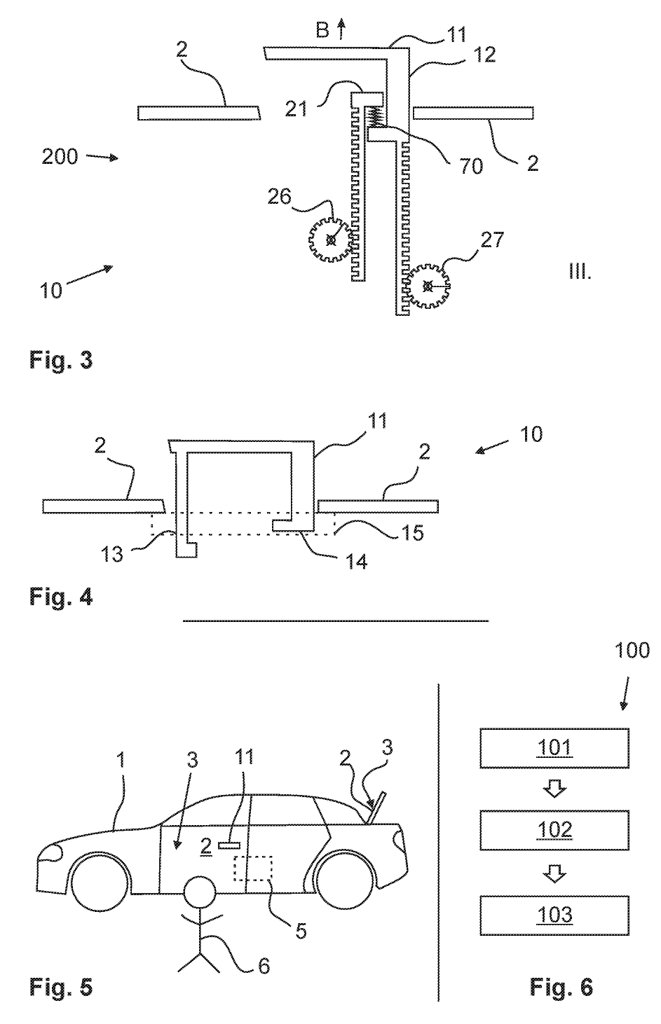

FIG. 3: another schematic illustration of parts of an acquisition system according to the invention as well as of a handle device according to the invention;

FIG. 4: a schematic illustration of parts of the handle device according to the invention;

FIG. 5: a schematic side view on to a vehicle and

FIG. 6: a schematic illustration for the visualization of a method according to the invention;

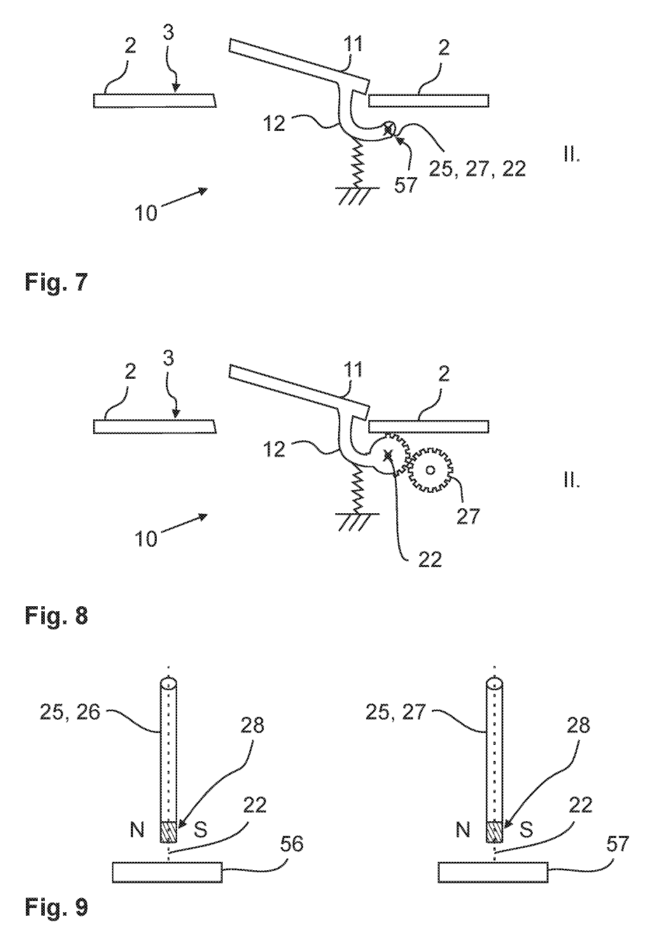

FIG. 7: a schematic illustration of parts of the handle device according to the invention;

FIG. 8: a further schematic illustration of parts of a handle device according to the invention; and

FIGS. 9 to 11: schematic illustrations of movement elements.

In the following Figures, identical reference characters are used for the same technical features even of different exemplary embodiments.

FIGS. 1 to 3 schematically show parts of a handle device 10 according to the invention with an acquisition system 200 according to the invention. Here, FIG. 1 shows a resting position I, FIG. 2 an operating position II, respectively first outward position II, and FIG. 3 shows a second outward position III of a handle part 11 of the handle device 10. Furthermore, it is discernible that in the resting position I, the handle part 11 is flush with an outer surface 3 of a movable part 2 of a vehicle 1. An actuation of the handle part 11 by a user 6 is therefore not possible in the resting position I.

Only by a first motion course A of a movement device 20, the handle part 11 is moved from the resting position I into the operating position II, so that the handle part 11 can be actuated manually. This procedure, in particular the triggering of the first motion course A, can e.g. be initiated in a detection of an approach of the user 6 to the vehicle 1. In the Figures, motion courses A, B are illustrated purely schematically by means of an arrow.

In order that the handle part 11 can be moved by means of the first motion course A, the movement device 20 includes at least one movement element 25. This way, a first movement element 26, in particular an active movement element 26, can directly or indirectly be connected with a drive device 30. This way, a movement of the drive device 30 can be transmitted to the first movement element 26, which is thereby brought into a rotation, for example. Accordingly, the movement elements 25 can e.g. be configured as gears, or shafts or axles or a lift bearing, which are rotatably supported in the handle device 10. The movement of the first movement element 26 can then be transmitted to a transmission element 60, wherein the transmission element 60 is transferred into an e.g. translatory movement. Of course, the movement can be of a different type, and likewise include a rotary movement or the like, for example. In addition, the transmission element 60 may comprise an actuation region 21, which is in direct operative connection with the handle part 11. The transmission element 60 then pushes against the handle part 11 with the actuation region 21, so that the handle part 11 is moved in the direction of the arrow A from the resting position I into the operating position, respectively first outward position II.

In addition, the handle part 11 is in operative connection with a second movement element 27, in particular a passive movement element 27, via a handle transmission element 27. In this case, the movement elements 25 are arranged and/or are rotatably mounted on a fixed axle 22, so that the translatory movement of the handle part 11 does not lead to a translatory movement of the movement elements 25. In particular, the movement of the handle part 11 results exclusively in a rotatory movement of the movement elements 25. This way, disturbing influences on the handle part 11, which do not serve an actuation, do not have any disturbing effect on the movement of the movement elements 25. Error influences can be compensated thereby.

As can in particular be taken from FIG. 4, the movement elements can be arranged on a carrier element 15, in particular mounting carrier 15, of the handle device 10. Preferably, in this case, it can also be possible that a first movement element 26 is arranged on a first bar 13, and a second movement element 27 is arranged on a second bar 14.

It can be taken from FIGS. 1 to 3 that the movements of the movement elements 25 occur similar in a first motion course A, and differently in a second motion course B. This different transmission of the movement of the handle part 11 in the second motion course B allows a particularly reliable and unambiguous detection of the actuation of the handle part 11. This actuation then in particular serves to activate and/or actuate a closing device 5.

In the operating position II, in particular a first outward position II, the handle part 11 can be actuated in that a short stroke in the direction of arrow B is carried out on the handle part 11.

To that end, a user 6 e.g. pulls on the handle part 11 in the direction away from the movable part 2, as is indicated by arrow B. The handle part 11 is thereby transferred in a second outward position III (c.f. FIG. 3).

Said second motion course B, i.e. in particular the transfer of the handle part 11 from the operating position II to the second outward position III, is transmitted owing to a decoupling element 70 (primarily) only to the second movement element 27. In other words, in the second motion course B, a transmission of the movement between the handle part 11 and the movement elements 25 different from that in the first motion course A occurs. To that end, the decoupling element 70 is in particular configured as a spring, which is able to absorb the kinetic energy of the handle part 11 from the movement from the operating position II to the second outward position III.

FIG. 5 shows that the handle part 11 can be configured for opening of a movable part 2. The movable part 2 can in particular be formed as a door and/or as a trunk lid of the vehicle 1. Of course, the handle part 11 can therefore likewise be arranged on the trunk lid, or on another part of the vehicle 1.

A method 100 according to the invention is schematically illustrated according to FIG. 6. According to a first method step 101, a first detection is conducted through at least one comparison sensor element 56 for establishing a first detection result. According to a second method step 102, a second detection is conducted through at least one actuation sensor element 57 for establishing a second detection result. According to a third method step 103, a comparison of the first detection result with the second detection result is conducted for establishing a comparison result, so that by means of the comparison, the second motion course B can be detected, in order to detect the actuation of the handle part 11.

As can be taken from FIG. 1, the comparison sensor element 56 can be arranged in the region of the first movement element 26, and the actuation sensor element 57 can be arranged in the region of the second movement element 27. The first and second detection can in this case be assessed by an assessment device 80, for example.

FIGS. 7 and 8 schematically show parts of the handle device 10 according to the invention. It can be seen here that the handle part 11 is formed as a rotary handle or pull handle 11, respectively, which is rotatably mounted about a rotary axle 22. In the movement from the resting position I to the operation position II and/or in the movement from the (first outward position II respectively the) operation position II to the second outward position III, or in the actuation, respectively, it can be possible for the handle part 11 to perform a rotational movement or a translatory movement, together with a rotational movement (pivoting movement). This movement e.g. is caused by the movement device 20.

Furthermore, it can be possible, according to FIG. 7, that a movement element 25, respectively the second movement element 27, is integrated in the rotary axle 22. In the region of or on the rotary axle 22, in particular of a bearing axle, a magnetic element 28 can preferably be attached. The magnetic element 28 is in particular arranged on a (e.g. first or second) movement element 25. The magnetic element can e.g. serve to be detected by the actuation sensor element 57. Here, the actuation sensor element 57 can likewise be integrated in the rotary axle 22 and/or be arranged in the region of the rotary axle 22, preferably in a magnetic field of the magnetic element 28. A first movement element 26 (not explicitly shown in FIG. 7) can of course also be provided, and be formed similar or differently relative to the second movement element 27. As is indicated in FIGS. 1 to 3, a drive device 30 and/or a transmission element 60 and/or a decoupling element 70 can further be provided in order to effect a movement of the handle part 11 from a resting position I to an operating position II. Of course, it can also be possible that exclusively an operating position II is provided as the initial position, and therefore the movement from the resting position I, and accordingly the drive device 30 and/or the transmission element 60 and/or the decoupling element 70 are not provided.

FIG. 8 shows another option for the configuration of the handle device 10 according to the invention. It can be seen here that a second movement element 27 can be arranged in the region of the rotary axle 22. In particular, the second movement element 27 is in operative connection with a handle transmission element 12 in such a way, that at least a rotary movement of the handle part 11 is transmitted to the second movement element 27. To that end, the second movement element 27 and/or the handle transmission element 12 is at least in part and/or at least in sections configured as a gear-mechanism element.

FIG. 9 schematically shows a first movement element 26 and a second movement element 27. Of course, further movement elements 25 can be provided, which are formed in such a way or in a similar way. The movement elements 25 are designed e.g. cylindrically and/or in each case include a magnetic element 28, which preferably has a north (N) and south (S) polarity (illustrated schematically). Thus, magnetic field can be generated, which is specific for a movement of the respective movement element 25. A sensor element (i.e. a comparison sensor element 56 or an actuation sensor element 57) can be arranged in the magnetic field, for the, in particular continuous, detection of the rotation of the movement elements 25 by a rotation of the magnetic elements 28.

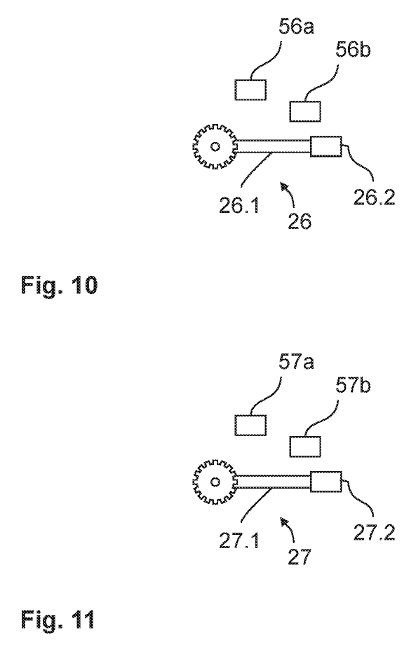

FIG. 10 shows that the first movement element 26 may comprise a lever 26.1, and that e.g. the comparison sensor element 56 comprises at least two sensor means 56a, 56b.

Advantageously, the sensor means 56a, 56b can be arranged at a distance, in order to detect a travel distance of a movement of the lever 26.1. To that end, an indicator, such as a magnetic element 26.2, can be fastened on the lever 26.1, the approaching of which can be detected by the sensor means 56a, 56b.

As an alternative or in addition, the second movement element 27 can also comprise a lever 27.1, as is illustrated in FIG. 11. Here, the actuation sensor element 57 can comprise at least two sensor means 57a, 57b, which can detect the movement of an indicator, such as a magnetic element 27.2, on the lever 27.1. This likewise allows a path distance measurement at the lever 27.1, to this way detect the rotary movement.

The above explanation of the embodiments describes the present invention exclusively by way of examples. It goes without saying that individual features of the embodiments, insofar as they are technically reasonable, can freely be combined with one another, without departing from the scope of the present invention.

### LIST OF REFERENCE CHARACTERS

1 vehicle
2 movable part, door, trunk lid
3 outer surface
5 closing device
6 user
10 handle device
11 handle part
12 handle transmission element
13 first bar
14 second bar
15 carrier element, mounting carrier
20 movement device
21 actuation region
22 axle
25 movement element, gear, shaft
26 first movement element, active movement element
26.1 lever of 26
26.2 magnetic element of 26
27 second movement element, passive movement element
27.1 lever of 27
27.2 magnetic element of 27
28 magnetic element
30 drive device
56 comparison sensor element, first sensor
56a first sensor means of 56
56b second sensor means of 56
57 actuation sensor element, second sensor
57a first sensor means of 57
57b second sensor means of 57
60 transmission element
70 decoupling element
80 assessment device
100 method
200 acquisition system
A first motion course
B second motion course
I resting position
II operating position, first outward position
III second outward position
N north
S south

1. An acquisition system for the detection of an actuation in a handle device of a vehicle, comprising a movement device for moving a handle part of the handle device from a resting position into an operating position, wherein
the movement device for effecting the movement of the handle part can be brought into a first motion course, and, after completed conduction of the first motion course, can be brought into a second motion course,
wherein
a comparison sensor element and an actuation sensor element are arranged on the movement device, so that the first motion course can be assessed by a first detection of the comparison sensor element and by a second detection of the actuation sensor element, and the second motion course can be assessed by the second detection of the actuation sensor element, whereby the actuation is detectable.

2. The acquisition system according to claim 1,
wherein
the movement device comprises a first movement element and a second movement element, which for the transmission of motion are coupled to one another at least in the first motion course, wherein the comparison sensor element is oriented towards the first movement element in order to detect a movement of the first movement element by means of the first detection, and the actuation sensor element is oriented towards the second movement element in order to detect a movement of the second movement element by means of the second detection.

3. The acquisition system according to claim 1,
wherein
the comparison sensor element and the actuation sensor element are connected to an assessment device, so that the first motion course of the movement device can be assessed using the first and second detection by means of the assessment device.

4. The acquisition system according claim 1,
wherein
the actuation sensor element and the comparison sensor element are configured as a sensor of the same type, preferably in each case as a rotation sensor, preferably a magnetic sensor.

5. A handle device for a movable part of a vehicle with a movably-mounted handle part and a movement device, wherein
through at least a first motion course of the movement device, the handle part can be moved from a resting position into an operating position, and the handle part can be manually actuated in the operating position, such that upon the actuation at least a second motion course of the movement device is effected,
wherein
at least a comparison sensor element and an actuation sensor element are arranged on the movement device, so that the first motion course can be assessed by a first detection of the comparison sensor element and by a second detection of the actuation sensor element, and the second motion course can be assessed by the second detection of the actuation sensor element, whereby the actuation of the handle part is detectable.

6. The handle device according to claim 5,
wherein
at least two movement elements of the movement device are provided, which in particular are configured as a rotatably-mounted gear on a stationary axle of the movement device, or as at least one rotatably-mounted shaft, wherein the comparison sensor element is oriented towards a first movement element and the actuation sensor element is oriented towards a second movement element, wherein the movement elements can in each case be brought into a different operative connection with the handle part, so that a first movement of the movement device in the first motion course can be detected by means of the comparison sensor element and the actuation sensor element, and a second movement of the movement device in the second motion course can be detected differently by the comparison sensor element and the actuation sensor element, so that the actuation is detectable by means of a comparison of the first and the second detection.

7. The handle device according to claim 5,
wherein
the comparison sensor element and the actuation sensor element are arranged in the region of different movement elements of the movement device, wherein the movement elements are in each case formed rotatable, so that preferably the comparison sensor element and the actuation sensor element are configured as rotation sensors for detection of a rotation of the movement elements.

8. The handle device according to claim 5,
wherein
the comparison sensor element and the actuation sensor element are arranged in the region of different movement elements of the movement device, wherein the movement elements are in each case formed to be translatorily-stationary with respect to the arrangement in the handle device, and preferably are arranged inside a carrier element, of the handle device.

9. The handle device according to claim 5, wherein
the actuation sensor element is configured as a short stroke sensor, so that the actuation of the handle part in the second motion course can be detected as a short stroke.

10. The handle device according to claim 5, wherein
the movement device is connected to a drive device, wherein a first movement element of the movement device can be directly driven by the drive device, so that a drive movement of the drive device can be transmitted to the first movement element, and can be transmitted to the handle part as a first movement in the first motion course and, indirectly, can be transmitted to a second movement element of the movement device.

11. The handle device according to claim 5, wherein
a first movement element of the movement device can be brought into operative connection with the handle part via a transmission element, so that a first movement can be transmitted from the first movement element to the transmission element and then to the handle part in the first motion course, wherein the first movement in the first motion course and a second movement in the second motion course can be transmitted from the handle part to the second movement element, wherein a decoupling element is provided, in order to at least compensate or prevent or change a transmission of the second movement of the handle part to the first movement element.

12. The handle device (12) according to claim 5, wherein
in the resting position, the handle part is arranged flush with the outer side of the movable part, and in the operating position, protrudes from the outer side of the movable part in a projection-like manner, so that a manual actuation, of the handle part can be conducted by a user of the vehicle.

13. The handle device according to claim 5, wherein
the movement elements are configured as translatory-stationary parts of the handle device, so that a translatory movement of the movement elements is essentially prevented by the movement of the handle part.

14. The handle device according to claim 5, wherein
an acquisition system for the detection of an actuation in a handle device of a vehicle, comprising a movement device for moving a handle part of the handle device from a resting position into an operating position,
wherein the movement device for effecting the movement of the handle part can be brought into a first motion course, and, after completed conduction of the first motion course, can be brought into a second motion course,
wherein a comparison sensor element and an actuation sensor element are arranged on the movement device, so that the first motion course can be assessed by a first detection of the comparison sensor element and by a second detection of the actuation sensor element, and the second motion course can be assessed by the second detection of the actuation sensor element, whereby the actuation is detectable is provided.

15. A method for the detection of an actuation of a handle device for a movable part of a vehicle, with a movably-mounted handle part and a movement device, wherein
the handle part is moved from a resting position into an operating position through at least a first motion course of the movement device, and the handle part can be actuated in the operating position, such that upon this actuation at least a second motion course of the movement device is effected,
the method comprising the following steps:
conducting at least a first detection by at least one comparison sensor element for establishing a first detection result,
conducting at least a second detection by at least one actuation sensor element for establishing a second detection result;
comparing the first detection result with the second detection result, for establishing a comparison result, so that by means of the comparison, the second motion course is detected, in order to detect the actuation of the handle part.

16. The method according to claim 15,
wherein
the movement device comprises a first movement element and a second movement element, which, in the first motion course are moved in a first type of motion, and in the second motion course in a second type of motion, so that the difference of the movement is specific to the actuation of the handle part.

17. The method according to claim 15,
wherein
in the operating position, the handle part for conducting the actuation for opening of the movable part, and for conducting at least one further, actuation, is unblocked, so that in a further actuation, at least one further course of movement of the movement device is effected,
wherein the movement device includes a first movement element and a second movement element, which in the further course of motion are moved in a first type of motion, in such a way, that the actuation for opening is distinguished from the at least one further actuation by means of the comparison result.

18. The method according to claim 15,
wherein
in the first motion course, the handle part is brought into a first outward position relative to the movable part, wherein then the actuation for opening the movable part is effected in that the handle part in the second motion course is manually brought into a second outward position by a user of the vehicle, whereby an increase of the distance to the outer surface of the movable part is effected, wherein the increase is detected using the comparison result.

19. The method according to claim 15, wherein
the second motion course is detected if
the actuation sensor element detects a required outward position of the handle part in the range of 1 mm to 10 mm, preferably 2 mm to 3 mm,
a such detection fails to appear in the comparison sensor element, preferably by means of the detection of a rotation of a first movement element, which preferably is permitted to amount to 1° to 2°.

20. The method according to claim 15,
wherein
the first motion course, determined by means of the first and second detection, in at least the comparing or assessing of the comparison result, is used as a reference for the detection of the actuation of the handle part, preferably for at least the calibration or configuration of a starting value for establishing at least the required outward position of the handle part or the required rotation, as of which the actuation is detected.

21. The method according to claim 15,
wherein
at least an acquisition system for the detection of an actuation in a handle device of a vehicle, comprising a movement device for moving a handle part of the handle device from a resting position into an operating position, wherein the movement device for effecting the movement of the handle part can be brought into a first motion course, and, after completed conduction of the first motion course, can be brought into a second motion course, wherein a comparison sensor element and an actuation sensor element are arranged on the movement device, so that the first motion course can be assessed by a first detection of the comparison sensor element and by a second detection of the actuation sensor element, and the second motion course can be assessed by the second detection of the actuation sensor element, whereby the actuation is detectable or a handle device) for a movable part of a vehicle, with a movably-mounted handle part and a movement device, wherein through at least a first motion course of the movement device, the handle part can be moved from a resting position into an operating position, and the handle part can be manually actuated in the operating position, such that upon the actuation at least a second motion course of the movement device is effected, wherein at least a comparison sensor element and an actuation sensor element are arranged on the movement device, so that the first motion course can be assessed by a first detection of the comparison sensor element and by a second detection of the actuation sensor element, and the second motion course can be assessed by the second detection of the actuation sensor element, whereby the actuation of the handle part is detectable is operable.
